(19) United States
(12) Patent Application Publication
(10) Pub. No.: US 2025/0209702 A1
(43) Pub. Date: Jun. 26, 2025

(54) METHOD AND APPARATUS OF TRANSFORMING GARMENT PATTERNS

(71) Applicant: CLO Virtual Fashion Inc., Seoul (KR)

(72) Inventors: Ho Hyun LEE, Seoul (KR); Phoebe GATTA, New York, NY (US); Ye Ji KIM, Seoul (KR); Joong Hyun HWANG, Seoul (KR)

(21) Appl. No.: 19/073,811

(22) Filed: Mar. 7, 2025

Related U.S. Application Data
(63) Continuation of application No. PCT/KR2024/015871, filed on Oct. 18, 2024.
(60) Provisional application No. 63/591,765, filed on Oct. 20, 2023.

(30) Foreign Application Priority Data
Oct. 18, 2024 (KR) 10-2024-0142761

(51) Int. Cl. G06T 11/60

(52) U.S. Cl. CPC G06T 11/60; G06T 2210/16

(57) ABSTRACT

A method and device for transforming a garment pattern are disclosed. The method includes receiving a selection input of a user with respect to a first pattern of two-dimensional (2D) garment patterns, determining a second pattern linked with the first pattern, generating a link between the first pattern and the second pattern, receiving a pattern transformation input of the user with respect to one of the first pattern and the second pattern, and displaying a transformation result of the first pattern and the second pattern on both the first pattern and the second pattern based on the pattern transformation input of the user.

### CROSS-REFERENCE TO RELATED APPLICATIONS

This is a bypass continuation application of International PCT Application No. PCT/KR2024/015871, filed on Oct. 18, 2024, which claims priority to U.S. Patent Application No. 63/591,765, filed on Oct. 20, 2023 and Republic of Korea Patent Application No. 10-2024-0142761, filed on Oct. 18, 2024, which are incorporated by reference herein their entirety.

### TECHNICAL FIELD

The following embodiments relate to a method and apparatus for transforming a garment pattern.

### BACKGROUND ART

A garment appears in three dimensions when worn on a person's body, but it is more in two dimensions because it is actually a combination of pieces of fabric cut according to a two-dimensional (2D) pattern. Because fabric, which is a material for a garment, is flexible, it may vary in shape according to a body shape or motion of a person who wears it.

For example, to transform a cut line and/or a sewing line having various shapes to apply a design element to a garment, transformation may need to be applied to not only a pattern including the cut line or the sewing line but also another pattern that is sewed or connected to the pattern.

### SUMMARY

According to an embodiment, by linking a link between two-dimensional (2D) garment patterns forming a 3D garment, an edit of a pattern may be applied to other patterns linked with the pattern.

According to an embodiment, an edit of an entirety of a linked pattern may be applied to a partial pattern or an edit of a linked partial pattern may be applied to the entire pattern.

According to an embodiment, a batch edit may be performed on an original pattern and a pattern that is copied from or traces the original pattern.

However, the technical aspects are not limited to the aforementioned aspects, and other technical aspects may be present.

A method of transforming a garment pattern, the method includes receiving a selection input of a user with respect to a first pattern of 2D garment patterns, determining a second pattern linked with the first pattern, generating a link between the first pattern and the second pattern, receiving a pattern transformation input of the user with respect to one of the first pattern and the second pattern, and displaying a transformation result of the first pattern and the second pattern on both the first pattern and the second pattern based on the pattern transformation input of the user.

The second pattern is a pattern that is linked with at least a portion of the first pattern.

The generating of the link includes determining whether preset points exist in the first pattern and the second pattern, and when it is determined that the preset points exist, generating the link by matching a preset first point in the first pattern with a preset second point in the second pattern.

The generating of the link includes, when it is determined that the preset points do not exist in at least one of the first pattern and the second pattern, generating the link by matching a first point of the first pattern with a second point of the second pattern, wherein the first point and the second point are determined based on a length ratio between a first line of the first pattern and a second line of the second pattern, with a second point of the second pattern.

The generating of the link includes determining whether preset sewing lines exist between the first pattern and the second pattern, and when it is determined that the preset sewing lines exist, generating the link using the preset sewing lines.

The pattern transformation input of the user includes at least one of an input to move a point positioned in a pattern in which the link is generated, an input to move a line segment positioned in the pattern in which the link is generated, and an input to transform a curvature corresponding to a curve of the pattern in which the link is generated.

The displaying of the transformation result includes determining whether to move the link based on the pattern transformation input of the user with respect to the one pattern, and according to the determination of whether to move the link, applying and displaying a transformation result of the one pattern and a link movement result of the other pattern linked with the one pattern.

The determining of whether to move the link includes determining whether to move the link based on a type of the pattern transformation input of the user based on a type of a link.

The type of the link includes at least one of a first type in which the link is generated between preset points, a second type in which the link is generated between a preset point and an arbitrary point on a curve, a third type in which the link is generated between the preset point and an arbitrary point on a straight line, a fourth type in which the link is generated between arbitrary points on the straight line, and a fifth type in which the link is generated between arbitrary points on the curve.

The determining of whether to move the link includes determining to perform the link movement when one of the first type, the second type, and the fifth type is included in a pattern that is transformed in response to the pattern transformation input of the user, and determining not to perform the link movement when the third type or the fourth type is included in the pattern that is transformed in response to the pattern transformation input of the user.

The displaying of the transformation result by applying the transformation result to both the first pattern and the second pattern includes setting a priority corresponding to the link according to whether the link is repeated or whether the link is flipped off, and applying the transformation result to the one pattern and the other pattern according to the priority.

The displaying of the transformation result by applying the transformation result to both the first pattern and the second pattern includes according to direction setting of the link, applying and displaying the transformation result, in which interlinked points are moved in a same or opposite direction in the first pattern and the second pattern, to both the first pattern and the second pattern.

According to an embodiment, an electronic device includes a user interface configured to receive a selection input of a user with respect to a first pattern of 2D garment patterns and receive a pattern transformation input of the user with respect to one of the first pattern and a second pattern, and a processor configured to determine the second pattern linked with the first pattern based on the selection input of the user with respect to the first pattern, generate a link between the first pattern and the second pattern, and apply and display a transformation result of the first pattern and the second pattern to both the first pattern and the second pattern based on the pattern transformation input of the user.

According to an aspect, an edit of a partial pattern of 2D garment patterns forming a 3D garment may be simultaneously applied to other patterns linked with the partial pattern.

According to an aspect, an edit of an entirety of an interlinked pattern may be applied to a partial pattern or an edit of an interlinked partial pattern may be applied to the entire pattern.

According to an aspect, a batch edit of an original pattern and a trace pattern that is copied from or traces the original pattern may be performed.

### BRIEF DESCRIPTION OF DRAWINGS

FIG. 1 is a flowchart of operations of a method of transforming a garment pattern, according to an embodiment.

FIGS. 2A, 2B, and 2C are diagrams illustrating a method of generating a link between a first pattern and a second pattern, according to an embodiment.

FIG. 3 is a diagram illustrating an example of editing a link line, according to an embodiment.

FIG. 4 is a flowchart of operations of a method of applying a transformation result to a first pattern and second pattern and displaying, according to an embodiment.

FIG. 5 is a diagram illustrating a process of applying a pattern transformation input of a user to a first pattern and a second pattern, according to an embodiment.

FIG. 6A is a diagram illustrating a pattern transformation input of a user is differently applied depending on link direction setting in editing properties corresponding to a link, according to an embodiment.

FIG. 6B is a diagram illustrating an example of a user interface (UI) for setting a link direction in editing properties corresponding to a link, according to an embodiment.

FIG. 7A is a diagram illustrating a setting method of a local coordinate system based on link movement, according to an embodiment.

FIG. 7B is a diagram illustrating an operating principle of link movement, according to an embodiment.

FIG. 8 is a diagram illustrating a method of determining whether to apply link movement to each type of a link, according to an embodiment.

FIG. 9 is a diagram illustrating a method of applying link movement according to a priority corresponding to a link, according to an embodiment.

FIG. 10 is a diagram illustrating a process of applying a pattern transformation input of a user by generating a link for a second pattern that the user traces a first pattern, according to an embodiment.

FIG. 11 is a diagram illustrating a screen on which a transformation result of 2D garment patterns is linked with a 3D garment and is displayed, according to an embodiment.

FIG. 12 is a block diagram of an electronic device for performing garment pattern transformation, according to an embodiment.

### DETAILED DESCRIPTION

The following detailed structural or functional description is provided as an example only and various alterations and modifications may be made to the embodiments. Here, the examples are not construed as limited to the disclosure and should be understood to include all changes, equivalents, and replacements within the idea and the technical scope of the disclosure.

In connection with the description of the drawings, like reference numerals may be used for similar or related components. It is to be understood that a singular form of a noun corresponding to an item may include one or more of the things, unless the relevant context clearly indicates otherwise.

As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof.

Terms, such as “first” or “second”, are simply used to distinguish a component from another component and do not limit the components in other aspects (e.g., importance or sequence). For example, a first component may be referred to as a second component, and similarly the second component may also be referred to as the first component.

It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like elements and a repeated description related thereto will be omitted.

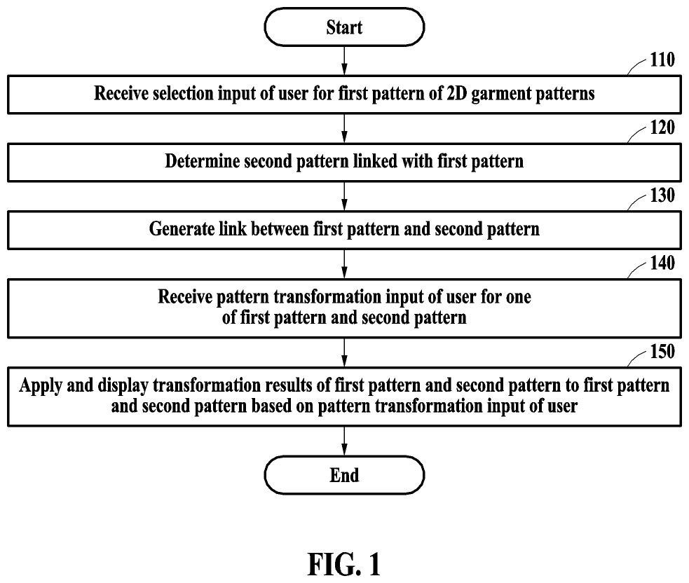

FIG. 1 is a flowchart of operations of a method of transforming a garment pattern, according to an embodiment. Referring to FIG. 1, a process in which an electronic device applies a pattern transformation input of a user to two-dimensional (2D) garment patterns and displays the 2D garment patterns to which the pattern transformation input is applied is illustrated.

Operations to be described hereinafter may be sequentially performed but not necessarily. For example, the order of the operations may change, and at least two of the operations may be performed in parallel.

In operation 110, the electronic device may receive a selection input of a user for a first pattern of 2D garment patterns. In this case, the “first pattern” may be referred to as an “original pattern” or a “target pattern”. The first pattern may be, for example, an entire pattern corresponding to a complete single garment, such as a shirt, trousers, or a dress, or may be a partial pattern that forms one garment, such as an upper garment right side front pattern, a lower garment back pattern. In this case, the “selection input of the user for the first pattern” may be selecting the entire first pattern or a partial area of the first pattern.

In operation 120, the electronic device may determine a second pattern linked with the first pattern, based on the selection input of the user for the first pattern received in operation 110. The “second pattern” may be a pattern linked with at least a portion of the first pattern. Specifically, a pattern linked with at least a portion of the first pattern may be a pattern that is linked with the entire first pattern or a partial area of the first pattern. More specifically, linking with at least a portion of the first pattern may include linking by forming a sewing relationship with at least a portion of the first pattern, linking by forming a relationship in which editing is simultaneously performed on at least a portion of the first pattern asymmetrically, and linking by forming a relationship in which editing is simultaneously performed on at least a portion of the first pattern symmetrically.

For example, when the first pattern is an upper garment's right side pattern, the electronic device may determine a partial pattern corresponding to a partial area in which a pocket is positioned in the upper garment's right side pattern. Alternatively, when the first pattern is a lower garment back pattern, the electronic device may determine the second pattern to be a partial pattern corresponding to a partial area in which a back pocket is positioned in the lower garment back pattern. Alternatively, when the first pattern is an upper garment's right side pattern, the electronic device may determine the second pattern to be a sleeve's right side pattern that is linked with and is in a sewing relationship with an armhole part of the upper garment's right side pattern. The size of the second pattern may be the same as the size of the first pattern or may be smaller. There may be one or more first patterns and/or second patterns.

In an embodiment, a 3D garment and 2D garment patterns may be formed by a mesh including a plurality of polygons. According to embodiments, the mesh may be modeled in various manners. For example, the vertices of a polygon included in the mesh may be point masses, and the sides of the polygon may be represented as elastic springs that connect the point masses. Thus, the 3D garment may be modeled by a mass-spring model, for example. The springs may have respective resistance values against, for example, stretch, shear, and bending, depending on the material property of the fabric used. Alternatively, the mesh may be modeled by a strain model. A polygon included in the mesh may be modeled, for example, as a triangle or as a polygon having four or more sides. In some examples, in case of needing to model a 3D volume, the mesh may be modeled as a 3D polyhedron.

The vertices of the polygon(s) included in the mesh may be moved by an external force such as gravity and an internal force such as stretch, shear, and bending. If a force applied to each vertex is obtained by calculating the external force and the internal force, the speed of displacement and movement of each vertex may be obtained. Movements of the garment may be simulated through the movements of the vertices of the polygon(s) constituting the mesh in each time step. For example, when a garment configured as a polygonal mesh is draped over a 3D avatar, a natural 3D virtual garment based on the law of physics may be implemented. The vertices of the polygon(s) included in the mesh may move according to the action of an external force such as gravity and the action of an internal force such as stretch, shear, and bending. When a force being applied to each vertex is obtained by calculating the external force and the internal force, the speed of movement and displacement of each vertex may be obtained. Also, a movement of the virtual garment may be simulated through movements of the vertices of the polygons of the mesh in each time step. When a 2D pattern formed of a polygonal mesh is draped over a 3D avatar, a 3D virtual garment with a natural look based on the law of physics may be implemented.

The 3D garment according to an embodiment may include, for example, at least one of a virtual garment that fits a body size of a user, a virtual garment for a 3D virtual character, and a virtual garment for a 3D virtual avatar.

The 2D garment patterns may correspond to respective body parts forming a 3D garment. The 2D garment pattern may be a virtual 2D pattern that is modeled as a set of polygons for simulating the 3D garment. The 2D patterns may include pattern pieces, and each of the pattern pieces may be modeled, for example, as a polygonal mesh based on the body shape of the 3D avatar. In this case, the polygonal mesh may include a plurality of polygons (e.g., a triangle or a rectangle).

In operation 130, the electronic device may generate a link between the first pattern and the second pattern. The electronic device may determine whether preset points exist in the first pattern and the second pattern. The preset points may correspond to, for example, each edge point that may define the shape of each pattern or a sewing point, a straight line point, a curve point, a dart point, a seam line, or a center point on a line segment of a straight line (or a curve) of each pattern. However, the example is not limited thereto.

A link according to an embodiment may be a connection for easy pattern editing for some of linked patterns (e.g., the first pattern and the second pattern). For example, when transforming the first pattern to edit the first pattern, the electronic device may apply and display a result of the transformation of the second pattern linked with the first pattern. As described above, the link may be for applying a result of organically applying a result of pattern transformation to the linked patterns.

For example, when it is determined that preset points exist in the first pattern and the second pattern, the electronic device may generate a link by matching a first point preset to the first pattern with a second point preset to the second pattern. In this case, there may be one or more first points and second points. Alternatively, when it is determined that preset patterns do not exist in at least one of the first pattern and the second pattern, the electronic device may generate a link by matching a first point of the first pattern with a second point of the second pattern, wherein the first point and the second point are determined based on a length ratio between a first line of the first pattern and a second line of the second pattern. The electronic device may match the first point of the first pattern with the second point of the second pattern based on a simple length ratio. The electronic device may set a range from 0 to 1 to the first line set in the first pattern. The electronic device may generate a link also in a range from 0 to 1 for the second line to be linked in the second pattern. Alternatively, when a point exists in the first line, the electronic device may identify position coordinates (e.g., 0.4, 0.7) of a position where the point is positioned in the range from 0 to 1 and may match the first point with the second point by determining the position of the second point on the second line to generate the link based on a ratio of the point on the first line.

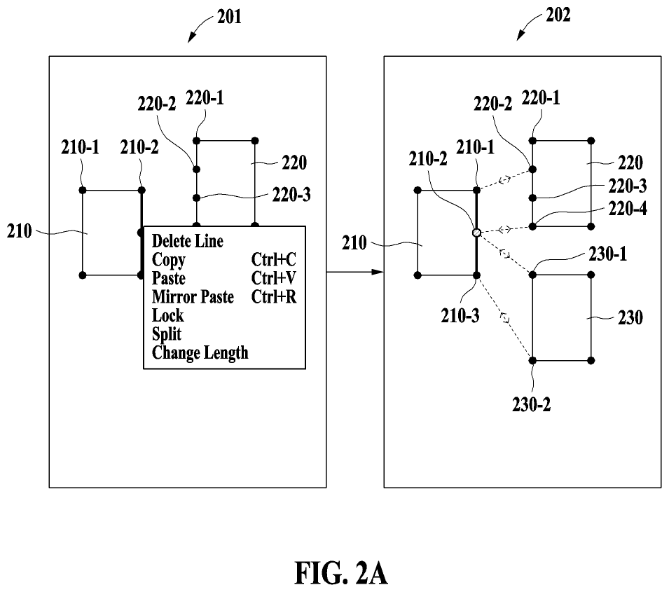

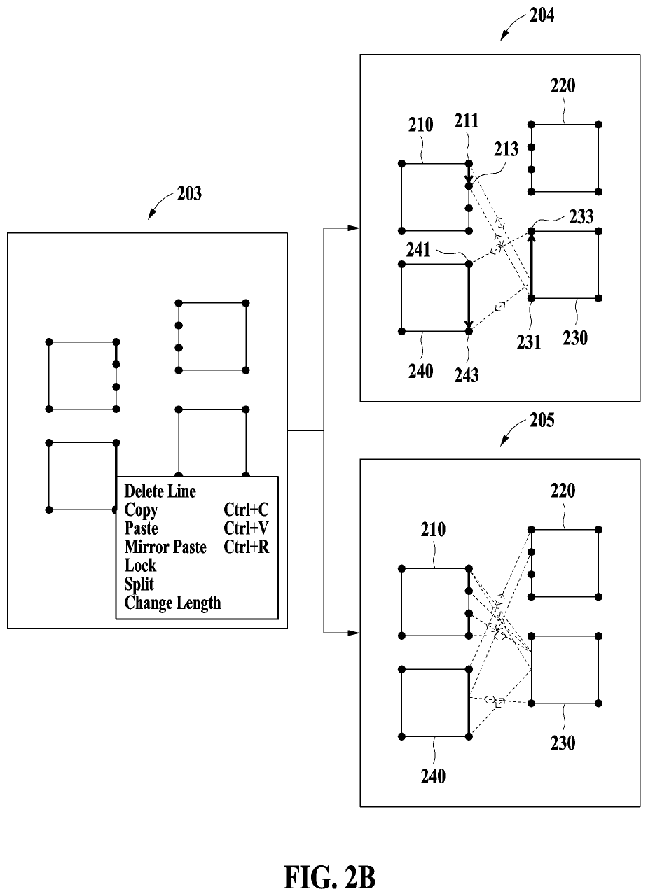

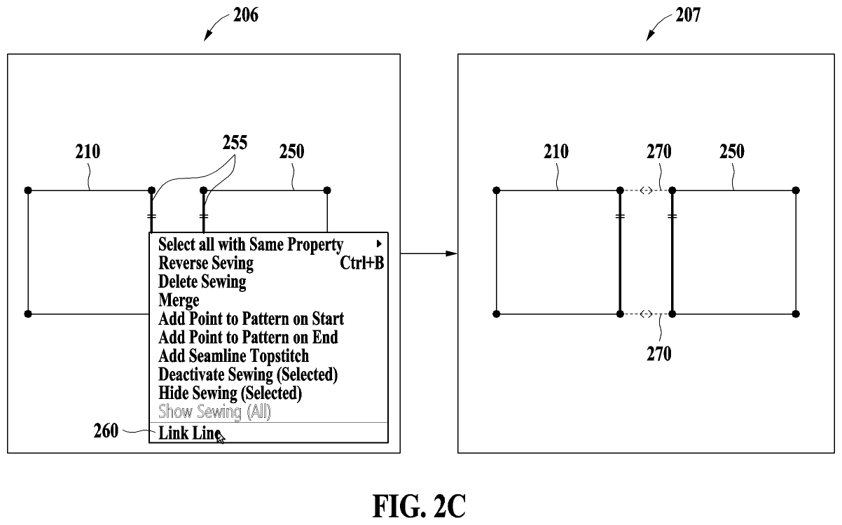

The method of generating the link based on the determination of the presence of preset points in the first pattern and the second pattern by the electronic device is further described with reference to FIGS. 2A and 2B below.

Alternatively, the electronic device may generate a link based on the determination of whether preset sewing lines exist between the first pattern and the second pattern. For example, when it is determined that preset sewing lines exist as a sewing pair between the first pattern and the second pattern, the electronic device may generate a link using the preset sewing lines. The electronic device may generate a link by connecting at least one link line between the preset sewing lines. The “link line” may be a line that connects patterns in which a link is generated therebetween, and for example, may be displayed as a dotted line including both arrows as link lines 270 of FIG. 2C. However, the example is not limited thereto. The method of generating the link by the electronic device based on the determination of the presence of preset sewing lines is further described with reference to FIG. 2C below.

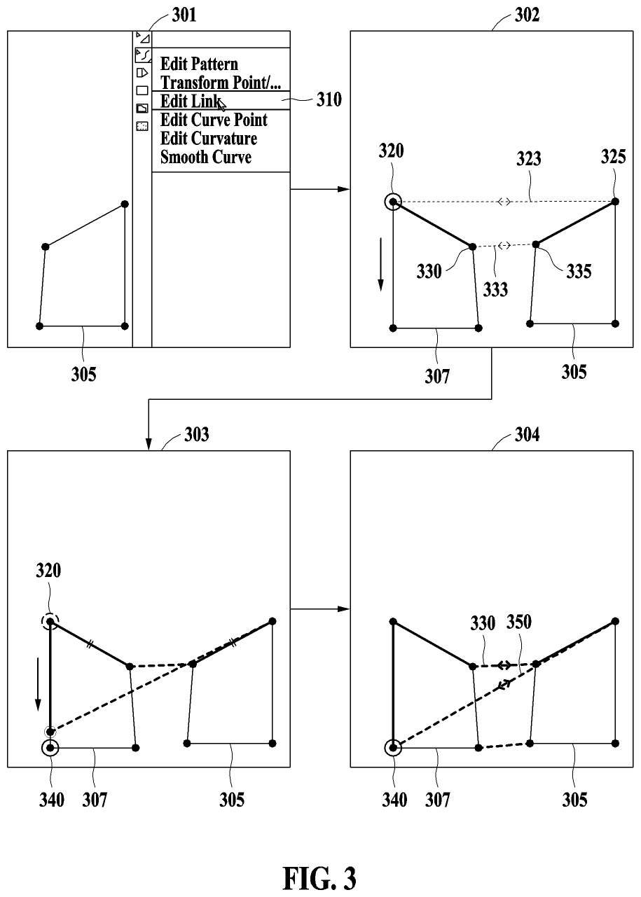

The electronic device may generate a link by connecting the first point of the first pattern and the second point of the second pattern linked to the first pattern to each other by at least one link line. The electronic device may change at least one of the first point, the second point, and the at least one link line by editing by the user. The method of changing at least one of the first point, the second point, and the at least one link line by editing by the user by the electronic device is further described with reference to FIG. 3 below.

In operation 140, the electronic device may receive a pattern transformation input of the user for one of the first pattern and the second pattern in which a link is generated (“linked”) in operation 130. The pattern transformation input of the user may include for example, at least one of an input to move a point positioned in the pattern in which the link is generated, an input to move a line segment positioned in the pattern in which the link is generated, and an input to transform a curvature corresponding to a curve of the pattern in which the link is generated. However, the example is not limited thereto.

In operation 150, the electronic device may apply and display transformation results of the first pattern and the second pattern to the first pattern and the second pattern based on the pattern transformation input of the user received in operation 140.

The electronic device may apply the pattern transformation input of the user with respect to one of the points positioned in one of the linked first pattern and the second pattern, line segments positioned in one of the patterns, and a curve of one of the patterns. For example, when the first pattern and the second pattern are patterns connected by sewing and the user transforms or modifies the first pattern by the link generated along the sewing line, the electronic device may identically apply the transformation or modification of the first pattern to the second pattern linked with the first pattern.

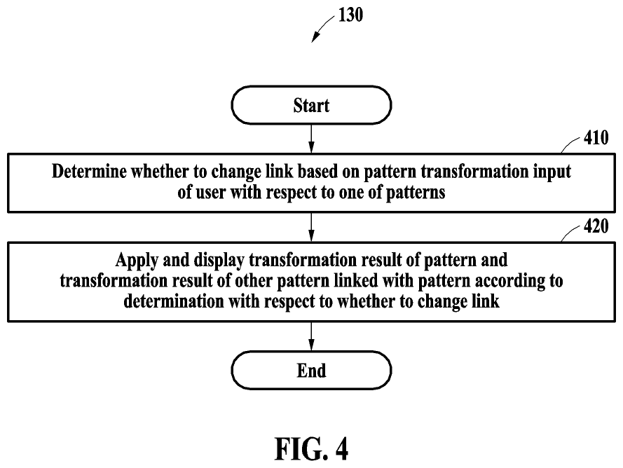

Based on the pattern transformation input with respect to a pattern, the electronic device may determine whether to apply link movement according to the pattern transformation input of the user to another pattern linked with the pattern. In accordance with the determination of whether to apply link movement, the electronic device may apply the pattern transformation input of the user to the pattern while applying link movement to the other pattern to perform simulation. The method of applying and displaying whether to change the link according to the pattern transformation input of the user to the first pattern and the second pattern by the electronic device is further described with reference to FIG. 4.

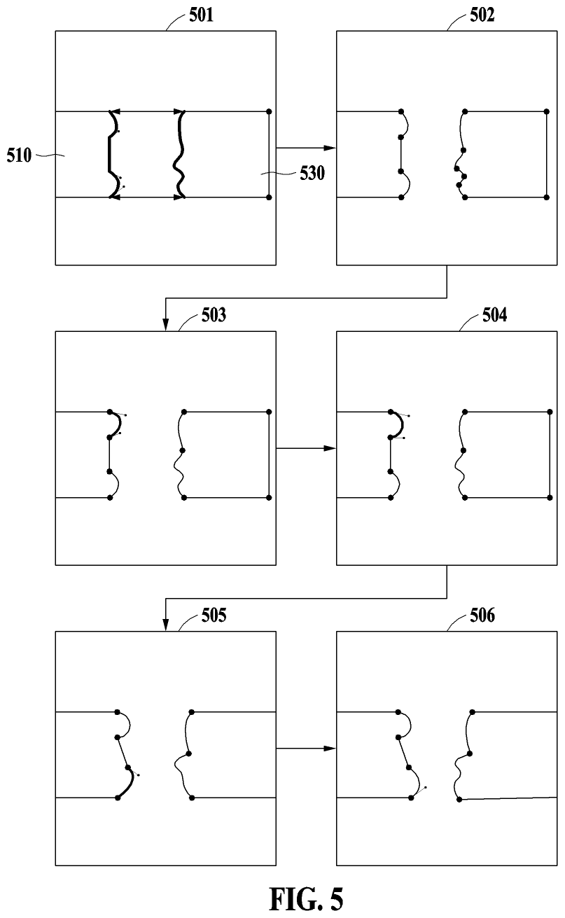

The process of applying the pattern transformation input of the user to the first pattern and the second pattern by the electronic device is further described with reference to FIG. 5 below.

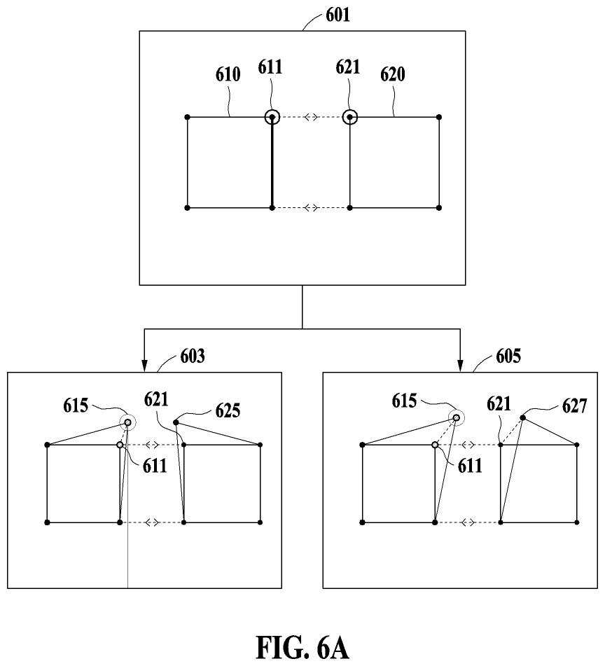

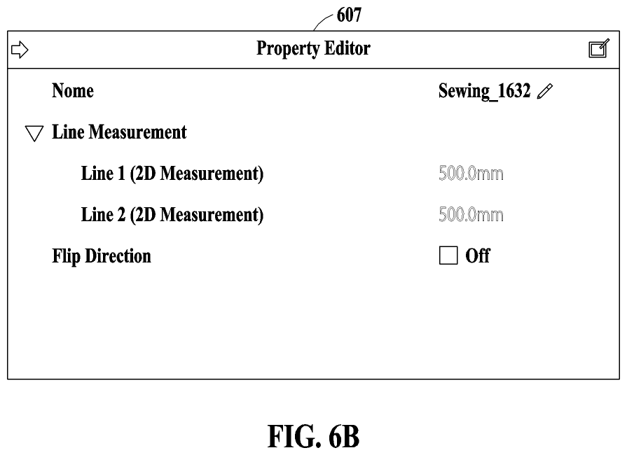

In addition, the electronic device may allow the user to edit various properties corresponding to the link. The electronic device may apply the pattern transformation input of the user to the patterns according to an edited property (e.g., setting a link direction) differently. The electronic device may apply and display a transformation result, in which interlinked points in the first pattern and the second pattern are moved in the same or opposite direction, to the first pattern and the second pattern. The method of editing a property corresponding to a link by the electronic device is further described with reference to FIGS. 6A and 6B below.

FIGS. 2A, 2B, and 2C are diagrams illustrating a method of generating a link between a first pattern and a second pattern according to an embodiment.

Referring to FIG. 2A, FIGS. 201 and 202 illustrating a method of generating a link by an electronic device according to an embodiment when preset points exist in the first pattern and the second pattern are illustrated.

The electronic device may generate a link between a pattern and another pattern or, as shown in FIG. 2A, may generate a link between a pattern (e.g., a first pattern 210) and the other two patterns (e.g., a second-first pattern 220 and a second-second pattern 230).

Referring to FIGS. 201 and 202, the first pattern 210 to which first points 210-1, 210-2, 210-3, and 210-4 are preset, the second-first pattern 220 to which second-first points 220-1, 220-2, 220-3, and 220-4 are preset, and the second-second pattern 230 to which second-second points 230-1, 230-2, 230-3, and 230-4 are preset are illustrated.

The electronic device may determine the presence of preset points in each of the patterns 210, 220, and 230. In this case, the presence of preset points may be included in information (e.g., metadata or pattern information) corresponding to each pattern.

When the preset points exist in each of the patterns 210, 220, and 230, the electronic device may generate a link by matching preset (or divided) points in each line of the patterns 210, 220, and 230.

As shown in the FIG. 202, a link line between the first point 210-1 of the first pattern 210 and the second-first point 220-2 of the second-first pattern 220 may be formed. The electronic device may form link lines between the first point 210-2 of the first pattern 210 and the second-first point 220-4 of the second-second pattern 220 and between the first point 210-2 of the first pattern 210 and the second-second point 230-1 of the second-second pattern 230. In addition, the electronic device may form a link line between the first point 210-3 of the first pattern 210 and the second-second point 230-2 of the second-second pattern 220.

For example, the electronic device may match pre-divided points in each line according to a distance ratio based on a point in which each pattern is sewed or may generate a link by matching points according to a predetermined matching rule for each point of each pattern.

Referring to FIG. 2B, FIGS. 203, 204, and 205 illustrating a method of generating a link by the electronic device according to an embodiment when preset points do not exist in at least one of the first pattern 210 and the second pattern 220 are illustrated.

For example, among the patterns shown in the FIG. 203, as shown in the FIG. 204, the first pattern 210 and the third pattern 230 may be linked with each other, and the second pattern 220 and the fourth pattern 240 may be linked with each other. In this case, as shown in the FIG. 203, preset points may exist in the first pattern 210 and the second pattern 220 and in the third pattern 230, and the fourth pattern 240, preset (or divided) points may not exist in a line (e.g., an outer line) of the fourth pattern 240 and the third pattern 230 except for vertices of pattern edges.

When a preset point does not exist in a line of each pattern (e.g., the third pattern 230 and the fourth pattern 240), the electronic device may generate a link to fit a length ratio of points existing in interlinked patterns (e.g., the first pattern 210 and the second pattern 220).

The electronic device may set a line set between a point 211 and an intermediate point 213 of the first pattern 210 and a line set between a point 231 and a point 233 of the third pattern 230 to be the “first line” and may set a line set between a point 241 of the fourth pattern 240 and a point 243 to be the “second line”. In this case, a margin may be provided when setting the first line. The electronic device may set starting points of the first line in the first pattern 210, may set the intermediate point 213 in the first pattern 210, and then, may continue to set the first line from the intermediate point 213 by moving to the third pattern 230 while pressing a key, for example, ctrl. The electronic device may determine the first line by setting the points 231 and 233 of the third pattern 230. In other words, the electronic device may determine the first line by setting the point 211, which is an upper point of the first pattern 210, to be a starting point and setting the point 231, which is a lower point of the third pattern 230, to be an ending point. In addition, when setting the second line in the fourth pattern 240, the electronic device may allow the second line that starts from the point 211 and ends at the point 231 to correspond to the first line by changing the starting point and the ending point of the second line continued to the points 241 and 243 of the fourth pattern 240.

As described above, the electronic device may generate two link lines connecting the first pattern 210 to the linked third pattern 230 by forming virtual points having the same length ratio by applying the length ratio between two points set on the right line of the first pattern 210 to a line, which faces the first pattern 210, of the linked third pattern 230.

In addition, as shown in the FIG. 205, the electronic device may generate two link lines connecting the second pattern 220 to the linked fourth pattern 240 by forming virtual points having the same length ratio by applying the length ratio between two points set on the left line of the second pattern 220 to a line, which faces the second pattern 220, of the linked fourth pattern 420.

As described above, when preset points do not exist in one of the interlinked patterns, the electronic device may generate a link by matching the first points of the first pattern with the virtual points of the second pattern such that the length or length ratio of the first line formed by the preset points matches the length or length ratio of the second line formed by the virtual points of the second pattern.

Referring to FIG. 2C, FIGS. 206 and 207 illustrating a method of generating a link by the electronic device according to an embodiment when preset sewing lines exist between the first pattern and the second pattern are illustrated.

For example, as shown in the FIG. 206, when preset sewing lines as a sewing pair exist between the first pattern 210 and a second pattern 250, lines 255 of facing surfaces between the first pattern 210 and the second pattern 250 may be sewed to each other. In this case, a preset sewing line shown in a dotted line may exist between the lines 255 sewed to each other. For example, the electronic device may identify whether sewing lines that are preset to be a sewing pair exist between the first pattern 210 and the second pattern 250 by pattern information corresponding to each pattern.

For example, when the user selects a “Link Line” function in correspondence with the lines 255 sewed to each other through a pop-up menu of a user interface (UI) 260 shown in the FIG. 206, the electronic device may set the preset sewing line to be a link line. As the preset sewing line is set to be the link line, the electronic device may change the preset sewing lines to link lines 270 including bidirectional arrow symbols as a screen 207. The link lines 270 may be shown as a line including a bidirectional arrow symbol, but is not limited thereto.

FIG. 3 is a diagram illustrating an example of editing a link line according to an embodiment. Referring to FIG. 3, FIGS. 301, 302, 303, and 304 sequentially illustrating a process of editing a link line according to an embodiment are illustrated.

For example, when the user selects an “Edit Link” function 310 from a pop-up menu corresponding to a first pattern 305 as shown in the FIG. 301, the electronic device may set link lines 323 and 335 to a changeable state (or a changeable mode) connected between the first pattern 305 and a linked second pattern 307 as shown in the FIG. 302. In this case, points 320 and 325 connected to the link line 323 and points 330 and 335 connected to the link line 333 may be referred to as “link points”.

The user may move the left top point (link point) 320 of the second pattern 307 shown in the FIG. 302 in a direction of a lower point 340 as shown in the FIG. 303. In this case, since the “Edit Link” function 310 is selected to edit the link lines 323 and 335, the electronic device may generate a new link line 350 between the first pattern 305 and the second pattern 307 as shown in the FIG. 304 by moving the link line 323 in the direction of the point 340. By the edit by the user, the link line 323 may be changed to the link line 350, and the positions of the points on the link line including the link points may also be moved.

As described further with reference to FIG. 5 below, points on a line segment linked (connected) with the link line may also be moved by the movement of the link points and this movement may be referred to as “indirect movement”.

When changing a link line, a pre-generated link line, a link line changed by the edit of the user, and sewing lines used as link lines may also be displayed on the screen.

FIG. 4 is a flowchart of operations of a method of applying a transformation result to a first pattern and second pattern and displaying according to an embodiment. Referring to FIG. 4, the electronic device according to an embodiment may display a transformation result on patterns through operations 410 and 420.

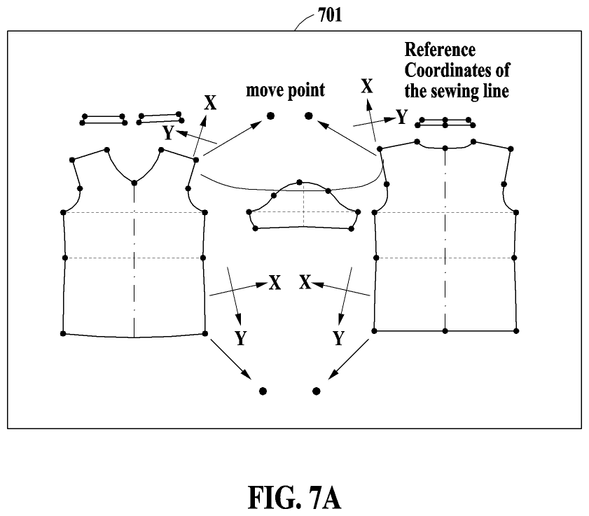

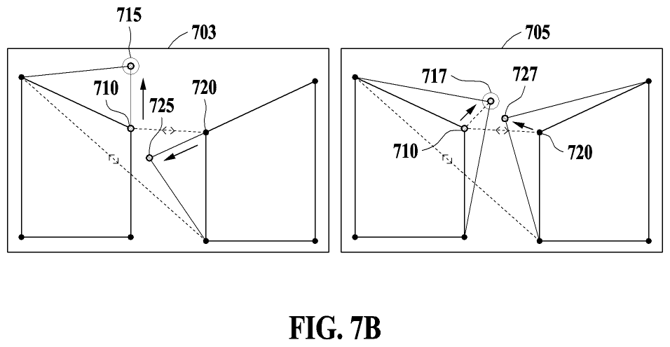

In operation 410, the electronic device may determine whether to move a link based on a pattern transformation input of a user with respect to one pattern. The electronic device may determine whether to apply link movement according to the pattern transformation input of the user to another pattern linked to the pattern. The electronic device may, for example, determine whether to perform link movement on the other pattern according to the pattern transformation input of the user with respect to one of a point and a line on one of the linked first pattern and the second pattern. The “link movement” may correspond to the movement of a line or a link point in linked patterns. In other words, the “link movement” may refer to the movement of the second pattern linked with the first pattern according to an input with respect to a point or a line including the link in the first pattern. In other words, the “link movement” may refer to the moving interlinked patterns together by the link. As a result of the “link movement”, outer lines of the patterns related to the link point or the line may be transformed. Accordingly, the electronic device may display the transformation result of the pattern. According to an embodiment, as a link point moves by the “link movement”, the length of a line segment of which an end point is the link point may extend or may be reduced. According to another embodiment, an area of the pattern may increase or decrease according to the link movement with respect to line segments or a linked point of linked patterns. In this case, the “interlinked patterns” may be construed to include any other patterns connected to directly linked patterns by sewing in addition to directly linked patterns by the link line. An operating principle of the link movement is further described with reference to FIGS. 7A and 7B below.

Based on the type of a link, the electronic device may determine whether to move the link according to a type of a pattern transformation input of the user (e.g., an input to move a point positioned in a pattern in which the link is generated, an input to move a line segment positioned in the pattern in which the link is generated, or an input to transform a curvature corresponding to a curve of the pattern in which the link is generated). For each type of link, the electronic device may determine whether to apply link movement according to the pattern transformation input of the user to the other pattern. In this case, the type of the link may include, for example, a first type generated between preset points, a second type generated between a preset point and an arbitrary point on a curve, a third type generated between a preset point and an arbitrary point on a straight line, a fourth type generated between arbitrary points on a straight line, and a fifth type generated between arbitrary points on a curve, but the example is not limited thereto. The first type may correspond to a link generated between a first point of one pattern and a second point of the other pattern. The second type may correspond to a link generated between the first point and an arbitrary second point on a curve of the other pattern. The third type may correspond to a link generated between the first point and an arbitrary second point on a straight line of the other pattern. The fourth type may correspond to a link generated between an arbitrary first point on a straight line of the one pattern and an arbitrary second point on a straight line of the other pattern. The fifth type may correspond to a link generated between an arbitrary curve of one pattern and an arbitrary curve of the other pattern.

For example, when the pattern transformation input of the user corresponds (matches) one of the first type, the second type, and the fifth type, the electronic device may determine to perform link movement. Accordingly, the electronic device may apply, to the other pattern, the link movement according to the pattern transformation input of the user. In addition, when the pattern transformation input of the user corresponds (matches) to one of the third type or the fourth type, the electronic device may determine not to perform link movement. Accordingly, the electronic device may not apply, to the other pattern, the link movement according to the pattern transformation input of the user.

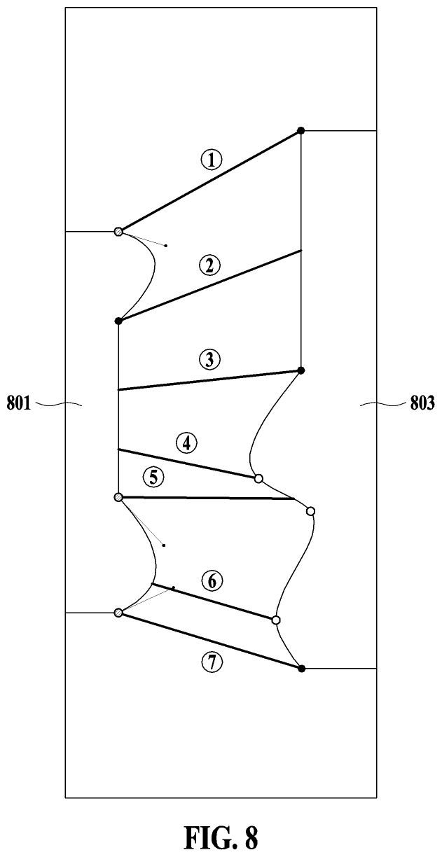

Depending on the embodiments, the electronic device may determine whether to apply, to the pattern or the other pattern, a curvature change according to the pattern transformation input of the user based on whether one of the first point of the pattern or the second point of the other pattern is a control point at which a curvature change is allowed. The electronic device may apply the curvature change to the other pattern based on the determination of whether to apply the curvature change. In this case, the control point at which the curvature change is allowed may correspond to, for example, a point including a Bezier handle shown in the first pattern in the first type of link of FIG. 8.

Alternatively, unlike the above descriptions, the type of link may be, for example, one of a first type \textcircled{1} in which a first point of the first pattern is a curve point positioned on a Bezier curve including a Bezier handle and a second point is a predetermined straight line point positioned on a straight line segment of the second pattern, a second type \textcircled{2} in which a first point of the first pattern is a predetermined straight line point positioned on a straight line segment of the first pattern and a second point is an arbitrary point that is not designated as a point on a straight line segment of the second pattern, a third type \textcircled{3} in which a first point of the first pattern corresponds to an arbitrary point that is not designated as a point on a straight line segment of the first pattern and a second point is a predetermined point on a straight line segment of the second pattern, a fourth type \textcircled{4} in which a first point of the first pattern corresponds to an arbitrary point that is not designated as a point on a straight line segment of the first pattern and a second point is a predetermined point on a curved line segment of the second pattern, a fifth type \textcircled{5} in which a first point of the first pattern is a predetermined first curve point positioned on a curved line segment of the first pattern and a second point is an arbitrary point that is not predetermined on a curved line segment of the second pattern, a sixth type \textcircled{6} in which a first point of the first pattern corresponds to an arbitrary point that is not designated as a point on a curved line segment of the first pattern and a second point is a predetermined curve point on a curved line segment of the second pattern, and a seventh type \textcircled{7} in which a first point of the first pattern corresponds to a predetermined curve point on a curved line segment (Bezier curve) of the first pattern and a second point is a predetermined straight line point on a curved line segment of the second pattern without Bezier, but the example is not limited thereto. The method of determining whether to move a link based on the type f link is further described with reference to FIG. 8 below.

In addition, the type of link may further include an indirect link in which an adjacent point or an adjacent line to a point on a linked line moves together by being affected by a link movement input.

In operation 420, the electronic device may apply and display a transformation result of the pattern and a transformation result of the other pattern linked with the pattern according to the determination in operation 410 with respect to whether to move a link.

The electronic device may set a priority corresponding to the link according to whether the link is repeated or flip off of the link. The electronic device may apply the link movement according to the set priority corresponding to the link. For example, the electronic device may set a priority corresponding to the link based on whether the link is a repeated link positioned between two links and whether the link is a flip off link of repeated links. The electronic device may set a high priority to the repeated link. In addition, the electronic device may set a high priority to the link that is set to flip off among the repeated links.

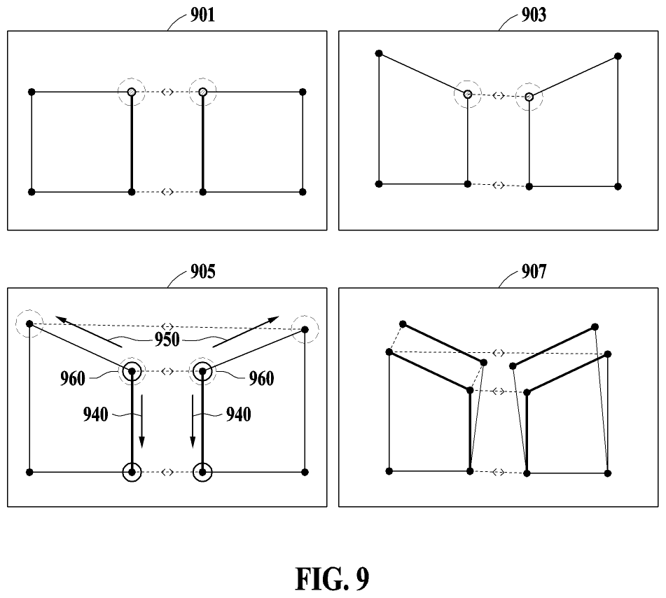

The electronic device may apply a transformation result to the pattern or the other pattern according to the priority. The electronic device may sequentially apply the link movement to the pattern or the other pattern according to the set priority. The method of applying the transformation result according to the set priority corresponding to the link is further described with reference to FIG. 9 below.

FIG. 5 is a diagram illustrating a process of applying a pattern transformation input of a user to a first pattern and a second pattern according to an embodiment. Referring to FIG. 5, FIGS. 501, 502, 503, 504, 505, and 506 illustrating a process of applying, to a first pattern 510 and a second pattern 530, a pattern transformation input of a user with respect to a pattern according to an embodiment are illustrated.

For example, as shown in the FIG. 501, straight line points positioned on a straight line of patterns and/or curve points positioned on a curve line of the patterns may correspond to link points forming a link line as shown in the FIG. 502. In this case, when the link points are moved as shown in the FIGS. 503 to 506 by editing (the pattern transformation input) by the user, points positioned on a line segment linked (connected) with a link line connected to the moved link points may also be moved together (“indirect movement”).

In addition, the electronic device may also perform link movement on points indirectly linked with the link points according to the movement of the link points. For example, when an indirect link in which a link is generated again is formed for a link-moved pattern, the electronic device may move a point and/or a line segment close to a point on the linked line segment by applying the influence of the link movement input. In this case, the “indirectly linked points” may be, when a link is set to a link-moved location, in other words, points moved by being affected by the link movement input among points (or line segments) near the point on the linked line (line segment).

The FIGS. 501 to 506 may reflect the “link movement operating principle” and may capture and arrange processes of performing link movement in time-series.

FIG. 6A is a figure to describe that a pattern transformation input of a user is differently applied according to the setting of a link direction of editing properties corresponding to a link according to an embodiment and FIG. 6B is a figure illustrating an example of a UI for setting a link direction to flip on or flip off in the editing properties corresponding to the link according to an embodiment.

Referring to FIGS. 6A and 6B, the FIG. 601 illustrating that a link line is formed between a first link point 611 of a first pattern 610 and a second link point 621 of a second pattern 620, a FIG. 603 illustrating a case in which a property (a flip direction) is set to flip off during the link editing as FIG. 6B, and the FIG. 605 illustrating a case in which a property is set to flip-on during the link editing are illustrated.

The electronic device may perform simulation to symmetrically move interlinked points in the first pattern 610 and the second pattern 620 or move in the same direction according to the setting of a link direction in editing properties corresponding to the link. In this case, the setting of the link direction may be determined by setting a flip function.

When moving the first link point 611 of the interlinked link points 611 and 621 upwardly in the FIG. 601, the second link point 621 linked with the first link point 611 may also be moved at a distance ratio in which the first link point 611 moves. In this case, the interlinked link points 611 and 621 may be symmetrically moved as the FIG. 603 or may be moved in the same direction as the FIG. 605.

For example, the user may set the link editing property to flip off through the UI as shown in the FIG. 607 of FIG. 6B. In this case, when moving a first link point 615 to the inside of the first pattern 610 as shown in the FIG. 603, a second link point 625 linked with the first link point 615 may also move to the inside of the second pattern 620. In addition, when moving the first link point 615 to the outside of the first pattern 610, the second link point 625 linked with the first link point 615 may also move to the outside of the second pattern 620.

When the link property is set to flip off, the electronic device may symmetrically move the interlinked points 615 and 625 in the first pattern 610, and the second pattern 620.

Alternatively, when the user presses a shortcut key (e.g., U) while moving the first link point 611 to the first link point 615 or sets a property setting in link edit to flip on, the electronic device may flip the link direction. In this case, when the user moves the first link point 615 to the inside of the first pattern 610 as shown in the FIG. 605, the electronic device may move a second link point 627 linked with the first link point 615 to the outside of the second pattern 620 according to the movement of the first link point 615. In addition, when the user moves the first link point 615 to the outside of the first pattern 610, the second link point 627 linked with the first link point 615 may move to the inside of the second pattern 620.

When the link property is set to flip on, the electronic device may move the interlinked link points 615 and 627 in the first pattern 610 and the second pattern 620 in the same direction.

Furthermore, the electronic device may identically apply transformation by an input of the user to a line that is in a symmetric relationship or instance relationship with a link line. In this case, the “instance relationship” with respect to a specific line or pattern may be a copied line or copied pattern from the corresponding line or pattern.

FIG. 7A is a diagram illustrating a setting method of a local coordinate system based on link movement according to an embodiment and FIG. 7B is a diagram illustrating an operating principle of link movement according to an embodiment.

Referring to a FIG. 701 of FIG. 7A and FIGS. 703 and 705 of FIG. 7B, an electronic device according to an embodiment may perform link movement by generating (x, y) coordinates of a local coordinate system based on a line to which a link is set even if a pattern is rotated or a shape of a line segment is different.

The electronic device may set a sewing proceeding direction with a set link to the Y axis in the FIG. 701. The electronic device may set a starting direction from a sewing notch, in other words, from a sewing starting direction to a sewing ending direction, to the Y-axis. In addition, the electronic device may set an axis orthogonal to a proceeding direction (e.g., the Y-axis) on a 2D plane to the X-axis. The X-axis may indicate whether a moving direction is inward or outward of the pattern, for example. In this case, when a flip option for setting a property (a flip direction) during link editing is on and when the flip option is off, the electronic device may set the X-axis opposite to each other.

Referring to FIG. 7B, FIGS. 703 and 705 showing cases in which the X-axis is flipped by using a flip function are illustrated.

When the flip option is set to on, if the user moves a first point 710 of the first pattern to a first point' 715 of the outer side of the first pattern as the FIG. 703, the electronic device may move a second point 720 of the second pattern linked with the first point 710 to a second point' 725 of the inner side of the second pattern. Alternatively, when the user moves the first point 710 of the first pattern to the inner side of the first pattern, the electronic device may move the second point 720 of the second pattern linked with the first point to the outer side of the second pattern.

Alternatively, when the flip option is set to off, if the user moves the first point 710 of the first pattern to a first point' 717 of the outer side of the first pattern as the FIG. 705, the electronic device may move the second point 720 of the second pattern linked with the first point 710 to a second point' 727 of the outer side of the second pattern. Alternatively, when the user moves the first point of the first pattern to the inner side of the first pattern, the electronic device may also move the second point of the second pattern linked with the first point to the inner side of the second pattern.

For example, the second point of the second pattern may be linked with the first point of the first pattern. In this case, the electronic device may link-move the second point together as the first point is moved. In addition, when moving the first point, if the second point is positioned on a line segment of the second pattern, the electronic device may curvature move the second point if the line segment of the second pattern is a curve and if the line segment of the second pattern is a straight line, the second point may not move and may remain in the original position.

FIG. 8 is a diagram illustrating a method of determining whether to apply link movement to each type of link according to an embodiment. Referring to FIG. 8, a diagram showing various link types (e.g., the first type \textcircled{1} to the seventh type \textcircled{7}) according to an embodiment is illustrated. When a link is set to various lines having different lengths, the electronic device may perform link movement according to the link type of each situation.

The rule of performing the link movement is as follows.

When the first point of the first pattern is moved, the electronic device may perform link movement on the second point of the second pattern linked with the first point. However, if the first point is moved but a point linked with the first point is not a preset second point in the second pattern and is an arbitrary point that is not designated as a point on a line segment of the second pattern, the electronic device may perform link movement only when the line segment of the second pattern is a curve and when the linked point is a straight line, the electronic device may not perform link movement.

For example, the first type \textcircled{1} may correspond to a case in which the first point of the first pattern is a curve point positioned on a Bezier curve including a Bezier handle and the second point is a predetermined straight line point positioned on a straight line segment of the second pattern.

In the first type \textcircled{1}, when a curve point on a curve of the first pattern is moved, the electronic device may perform link movement on the straight line point of the second pattern linked with the curve point of the first pattern. In this case, the curve of the first pattern may be, for example, a Bezier curve or a spline curve, but the example is not limited thereto.

The first curve point of the first pattern may include a Bezier handle in an arrow shape for curvature change. in this case, the user may change the curvature of the curve of the first pattern using the Bezier handle included in the first curve point. When the curvature editing is performed on the first curve point of the first pattern, the electronic device may not perform link movement on the straight line point of the second pattern.

The second type \textcircled{2} may correspond to a case in which the first point of the first pattern is a predetermined straight line point positioned on a straight line segment of the first pattern and the second point is an arbitrary point that is not designated as a point on the straight line segment of the second pattern.

The third type \textcircled{3} may correspond to a case in which the first point of the first pattern is an arbitrary point that is not designated as a point on a straight line segment of the first pattern and the second point is a predetermined point on the straight line segment of the second pattern.

The fourth type \textcircled{4} may correspond to a case in which the first point of the first pattern is an arbitrary point that is not designated as a point on a straight line segment of the first pattern and the second point is a predetermined point on the curved line segment of the second pattern.

If the pattern transformation input of the user corresponds to one of the second type \textcircled{2}, the third type \textcircled{3}, and the fourth type \textcircled{4}, the electronic device may perform link movement when moving an entirety of a straight line segment by selecting the straight line segment (itself) in the first pattern for the link movement because a linked point exists in the opposite side. However, when moving an arbitrary point on the straight line segment of the first pattern (e.g., when selecting one of both end points of the straight line segment and moving the point) and the second point of the second pattern linked with the first pattern is an arbitrary point of the line segment of the straight line, link movement may not be performed.

The fifth type \textcircled{5} may correspond to a case in which the first point of the first pattern is a predetermined first curve point positioned on a curved line segment of the first pattern and the second point is an arbitrary point that is not designated as a point on the curved line segment of the second pattern. In this case, the curve point of the first pattern may include a Bezier handle in an arrow shape for curvature change.

The sixth type \textcircled{6} may correspond to a case in which the first point of the first pattern is an arbitrary point that is not designated as a point on a curved line segment of the first pattern and the second point is a predetermined curve point on the curved line segment of the second pattern.

When the pattern transformation input of the user corresponds to one of the fifth type \textcircled{5} and the sixth type \textcircled{6}, the electronic device may perform link movement with applied curvature to the second curve of the second pattern linked with the first point when moving the first point of the first pattern. When performing link movement with curvature, the electronic device may perform link movement on the second point of the second pattern.

The seventh type \textcircled{7} may correspond to a case in which the first point of the first pattern corresponds to a predetermined curve point in a curved line segment (a Bezier curve) of the first pattern and the second point is a predetermined straight line point in a curved line segment without Bezier of the second pattern. In this case, the curve point of the first pattern may include a Bezier handle in an arrow shape for curvature change.

When the link type is the seventh type \textcircled{7}, the electronic device may perform curvature movement on the line segment of the second pattern using the Bezier handle on the Bezier curve.

As described above, for each type of link, the electronic device may determine whether to change a link according to the pattern transformation input of the user to the other pattern. The electronic device may determine whether to apply, to the pattern or the other pattern, a curvature change according to the pattern transformation input of the user based on whether one of the first point of the pattern or the second point of the other pattern is a control point at which a curvature change is allowed (e.g., a link point including a Bezier handle).

When multiple link movements are repeated, the electronic device may assign a priority corresponding to a link movement by a predetermined rule. The method of applying link changes according to the priority is further described with reference to FIG. 9 below.

FIG. 9 is a diagram illustrating a method of applying a link change according to a priority corresponding to a link according to an embodiment. Referring to FIG. 9, FIGS. 901, 903, 905, and 907 illustrating a method of changing a link according to an embodiment are illustrated.

The electronic device may perform a link change according to the following rule.

For example, when the user selects both the first point of the first pattern and the second point of the second pattern that are interlinked with each other as targets of link movement as shown in the FIG. 901 (in other words, when receiving pattern transformation inputs with respect to both the first point of the first pattern and the second point of the second pattern), the electronic device may not perform link movement.

When the user sets a link between the first point of the first pattern and the second point of the second pattern but as shown in the FIG. 903, the first pattern and the second pattern are symmetric patterns that are in a symmetric relationship or the second pattern is an instance pattern in a copy relationship with the first pattern, the electronic device may not perform link movement.

The electronic device may set a priority corresponding to the link based on whether the link is a repeated link positioned between two links and whether the link is a flip off link of repeated links. The electronic device may apply a transformation result by sequentially applying a link change to the pattern or the other pattern according to the priority.

For example, when a first link 940 and a second link 950 are set between the first pattern and the second pattern and repeatedly linked points 960 exist between the first link 940 and the second link 950, the electronic device may assign a high priority to a link that is line-moved with respect to the repeatedly linked points 960.

In addition, when the electronic device performs line movement with respect to repeatedly linked links, the electronic device may assign a higher priority to a flipped-off link. In other words, the electronic device may assign a higher priority to the second link 950 that is line-moved than the first link 940 that is point-moved.

In an embodiment, setting (or assigning) a priority to repeated links with multiple repeated links may prevent patterns from being individually moved by coordinate movement based on different references for moving directions of points.

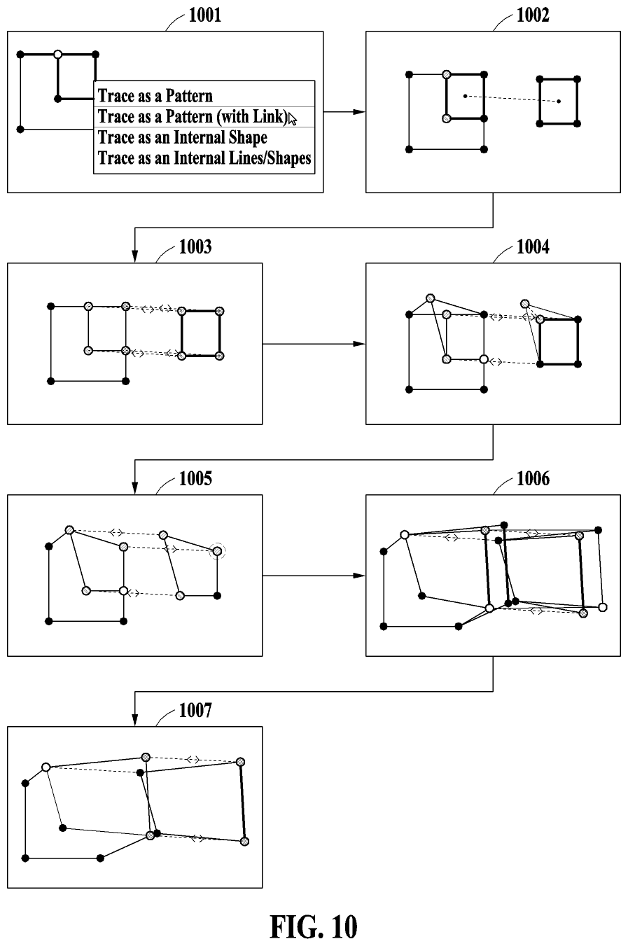

FIG. 10 is a diagram illustrating a process of applying a pattern transformation input of a user by generating a link for a second pattern that the user traces a first pattern according to an embodiment. Referring to FIG. 10, FIGS. 1001, 1002, 1003, 1004, 1005, 1006, and 1007 sequentially showing processes of generating a trace pattern while generating a link with the trace pattern by an electronic device as a user selects a “Trace Pattern with Link” function through a UI according to an embodiment are illustrated.

The user may select a “Trace as a Pattern (with Link)” function to trace a portion of a first pattern (e.g., an upper garment pattern of a garment) as the FIG. 1001. In this case, as the FIG. 1002, a second pattern (e.g., a pocket pattern) that copies a portion selected by the user from the first pattern may be generated and a link may be generated by a link line connecting the first pattern and the second pattern as the FIG. 1003.

In this case, editing of the second pattern may be identically applied to the first pattern as the FIGS. 1004, 1005, 1006, and 1007, and editing of the first pattern may also be identically applied to the second pattern. In addition, the same editing for each pattern may be allowed by setting a link between the first pattern and the second pattern while sewing is not set. The electronic device may perform batch editing of the second pattern that traces the first pattern and the first pattern that is the original pattern by applying an edit of the linked entire pattern to a partial pattern and/or applying an edit of a linked partial pattern to the entire pattern.

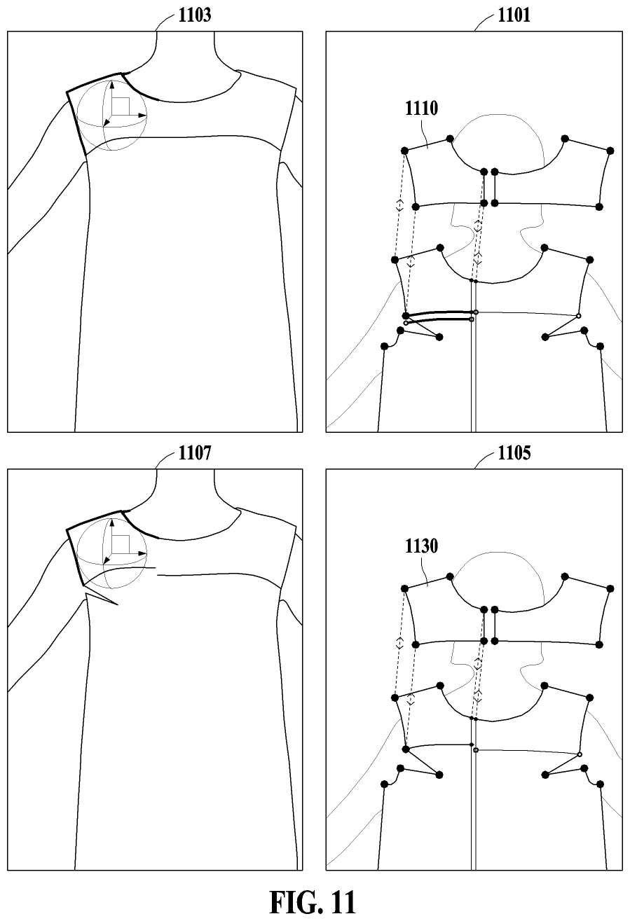

FIG. 11 is a diagram illustrating a screen on which a transformation result of 2D garment patterns is linked with a 3D garment and is displayed according to an embodiment. Referring to FIG. 11, a FIG. 1101 illustrating 2D garment patterns 1110 according to an embodiment and a FIG. 1103 illustrating a 3D garment displayed by being linked with the 2D garment patterns 1110 are illustrated.

For example, when a position of a dart line connected to an upper garment right sleeve in the 2D garment patterns 1110 is changed to 2D garment patterns 1130 shown in a FIG. 1105 by a pattern transformation input of the user, the electronic device may display a 3D garment corresponding to the changed 2D garment patterns 1130 as a FIG. 1107. In this case, as the pattern transformation input (e.g., changing the position of the dart line) of the user performed in the FIG. 1105 is displayed by being linked with the 3D garment shown in the FIG. 1107, a right dart line of the FIG. 1107 may be apart.

As described above, in an embodiment, the user may easily identify an edit result by identically applying an edit of the 2D garment pattern to the 3D garment by linking a pattern transformation input (e.g., an edit of the pattern (or a change in the setting of the pattern)) of the user for the 2D garment patterns with the 3D garment.

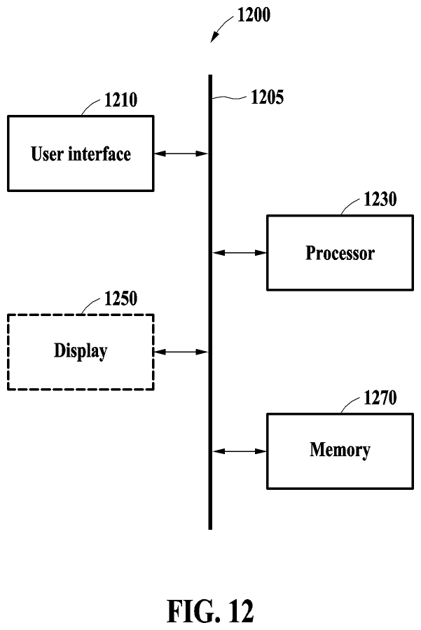

FIG. 12 is a block diagram of an electronic device for performing garment pattern transformation according to an embodiment. Referring to FIG. 12, an electronic device 1200 according to an embodiment may include a UI 1210, a processor 1230, a display 1250, and a memory 1270. The UI 1210, the processor 1230, the display 1250, and the memory 1270 may be connected to each other via a communication bus 1205.

The UI 1210 may display 2D garment patterns (e.g., the first pattern and the second pattern) for a 3D garment and/or the 3D garment. The UI 1210 may receive a selection input of a user with respect to the first pattern of the 2D garment patterns. The UI 1210 may receive a pattern transformation input of the user with respect to one of the first pattern and the second pattern. The UI 1210 may receive an input of the second pattern selected by the user in association with the first pattern of the 2D garment patterns. For example, the UI 1210 may receive a user input with respect to the 2D garment patterns displayed in a 3D space through a stylus pen or a mouse click.

The processor 1230 may determine the first pattern and the second pattern based on a selection input of the user with respect to the first pattern or a random selection input of the user with respect to the first pattern and the second pattern. For example, when the user inputs a selection input with respect to the first pattern, the processor 1230 may automatically determine the second pattern linked with the first pattern. This may be a case in which the first pattern and the second pattern are linked in a sewing relationship. For example, when the user inputs a selection input that randomly selects from the first pattern and the second pattern, the processor 1230 may determine the first pattern and the second pattern by a link between the first pattern and the second pattern.

The processor 1230 may generate a link between 2D garment patterns (e.g., the first pattern and the second pattern) displayed through the UI 1210. The processor 1230 may apply and display, on the display 1250, a transformation result for the first pattern and the second pattern to the first pattern and the second pattern based on a pattern transformation input of the user with respect to one of the first pattern and the second pattern in which a link is generated (“linked”). A simulation may be performed.

The display 1250 may output at least one of the 2D garment patterns and/or the 3D garment to which the transformation result for the patterns is applied by the processor 1230. The display 1250 may display the 2D garment patterns and/or the 3D garment to which the pattern transformation input is applied by the processor 1230.

The memory 1270 may store information on the second pattern selected by the user, wherein the information is received through the UI 1210. The information on the second pattern may include, for example, position coordinates of the second pattern, the size of the second pattern, a distance, and a direction from the first pattern to the second pattern, but the example is not limited thereto.

The memory 1270 may store information on the first pattern and the second pattern in which a link is generated and/or information on the pattern transformation input of the user with respect to the first pattern and the second pattern. The memory 1270 may store a result (e.g., the 2D garment patterns and/or the 3D garment) of simulation that is performed by applying the pattern transformation input of the user to the first pattern and the second pattern.

Further, the memory 1270 may store a variety of information generated in the processing process of the processor 1230 described above. According to an embodiment, the memory 1270 may store a program implementing the garment pattern transformation method described with reference to FIGS. 1 to 11 above. In addition, the memory 1270 may store a variety of data and programs. The memory 1270 may include volatile memory or non-volatile memory. The memory 1270 may include a high-capacity storage medium such as a hard disk to store a variety of data.

In addition, the processor 1230 may perform at least one of the methods described with reference to FIGS. 1 through 11 or an algorithm corresponding to at least one of the methods. The processor 1230 may be a hardware-implemented data processing device having a circuit that is physically structured to execute desired operations. For example, the desired operations may include code or instructions in a program. The processor 1230 may be implemented as, for example, a CPU, a GPU, or an NPU. The electronic device 1200 that is implemented as hardware may include, for example, a microprocessor, a CPU, a processor core, a multi-core processor, a multiprocessor, an application-specific integrated circuit (ASIC), and a field-programmable gate array (FPGA).

The processor 1230 may execute a program and may control the electronic device 1200. Program code to be executed by the processor 1230 may be stored in the memory 1270.

The electronic device 1200 according to an embodiment may receive data from the user through an I/O device and may output generated data. For example, the electronic device 1200 may receive an input (e.g., selection of 2D garment patterns) of the user through the I/O device and may output a result of applying a pattern transformation input of the user to the 2D garment patterns by a link generated according to the user's input. The electronic device 1200 may be connected to the external device (e.g., a personal computer (PC) or a network) through the I/O device and may exchange data with the external device.

The electronic device 1200 according to an embodiment may further include other components not shown in the drawings. For example, the electronic device 1200 may further include a communication module that provides a function for the electronic device 1200 to communicate with other electronic devices or servers via a network. In addition, for example, the electronic device 1200 may further include other components such as a transceiver, various sensors, and a database.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

As described above, although the embodiments have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

What is claimed is:

1. A method of transforming a garment pattern, the method comprising:
receiving a selection input of a user with respect to a first pattern of two-dimensional (2D) garment patterns;
determining a second pattern linked with the first pattern;
generating a link between the first pattern and the second pattern;
receiving a pattern transformation input of the user with respect to one of the first pattern and the second pattern; and
displaying a transformation result of the first pattern and the second pattern on both the first pattern and the second pattern based on the pattern transformation input of the user.

2. The method of claim 1, wherein the second pattern is a pattern that is linked with at least a portion of the first pattern.

3. The method of claim 1, wherein the generating of the link comprises:
determining whether preset points exist in the first pattern and the second pattern; and
responsive to determining that the preset points exist, generating the link by matching a preset first point in the first pattern with a preset second point in the second pattern.

4. The method of claim 3, wherein the generating of the link comprises:
responsive to determining that the preset points do not exist in at least one of the first pattern and the second pattern, generating the link by matching a first point of the first pattern with a second point of the second pattern, wherein the first point and the second point are determined based on a length ratio between a first line of the first pattern and a second line of the second pattern, with a second point of the second pattern.

5. The method of claim 1, wherein the generating of the link comprises:
determining whether preset sewing lines exist between the first pattern and the second pattern; and
responsive to determining that the preset sewing lines exist, generating the link using the preset sewing lines.

6. The method of claim 1, wherein the pattern transformation input of the user comprises at least one of (i) an input to move a point positioned in a pattern in which the link is generated, (ii) an input to move a line segment positioned in the pattern in which the link is generated, or (iii) an input to transform a curvature corresponding to a curve of the pattern in which the link is generated.

7. The method of claim 1, wherein the displaying of the transformation result comprises:
determining whether to move the link based on the pattern transformation input of the user with respect to the one pattern; and
according to the determination of whether to move the link, applying and displaying a transformation result of the one pattern and a link movement result of the other pattern linked with the one pattern.

8. The method of claim 7, wherein the determining of whether to move the link comprises:
determining whether to move the link based on a type of the pattern transformation input of the user based on a type of a link.

9. The method of claim 8, wherein the type of the link comprises at least one of:
a first type in which the link is generated between preset points;
a second type in which the link is generated between a preset point and an arbitrary point on a curve;
a third type in which the link is generated between the preset point and an arbitrary point on a straight line;
a fourth type in which the link is generated between arbitrary points on the straight line; or a fifth type in which the link is generated between arbitrary points on the curve.

10. The method of claim 9, wherein the determining of whether to move the link comprises:
determining to perform the link movement when one of the first type, the second type, and the fifth type is included in a pattern that is transformed in response to the pattern transformation input of the user; and
determining not to perform the link movement when the third type or the fourth type is included in the pattern that is transformed in response to the pattern transformation input of the user.

11. The method of claim 7, wherein the displaying of the transformation result by applying the transformation result to both the first pattern and the second pattern comprises:
setting a priority corresponding to the link according to whether the link is repeated or whether the link is flipped off; and
applying the transformation result to the one pattern and the other pattern according to the priority.

12. The method of claim 1, wherein the displaying of the transformation result by applying the transformation result to both the first pattern and the second pattern comprises:
according to direction setting of the link, applying and displaying the transformation result, in which interlinked points are moved in a same or opposite direction in the first pattern and the second pattern, to both the first pattern and the second pattern.

13. An electronic device comprising:
a user interface device configured to receive a selection input of a user with respect to a first pattern of two-dimensional (2D) garment patterns and receive a pattern transformation input of the user with respect to one of the first pattern and a second pattern; and
one or more processors configured to:
determine the second pattern linked with the first pattern based on the selection input of the user with respect to the first pattern,
generate a link between the first pattern and the second pattern, and
apply and display a transformation result of the first pattern and the second pattern to both the first pattern and the second pattern based on the pattern transformation input of the user.
